(19) United States
(12) Patent Application Publication
(10) Pub. No.: US 2026/0249325 A1
(43) Pub. Date: Aug. 27, 2026

(54) VIBRATORY SCREENING APPARATUS

(71) Applicant: General Kinematics Corporation, Crystal Lake, IL (US)

(72) Inventors: Thomas Musschoot, Marengo, IL (US); Eric Dickinson, Crystal Lake, IL (US); Steve Massman, Poplar Grove, IL (US); Alan Grove, Wonder Lake, IL (US); Robert Huffer, Cape Coral, FL (US)

(21) Appl. No.: 19/542,267

(22) Filed: Feb. 17, 2026

Related U.S. Application Data
(60) Provisional application No. 63/763,655, filed on Feb. 26, 2025.

(51) Int. Cl. B07B 1/28; B07B 1/46

(52) U.S. Cl. CPC B07B 1/286; B07B 1/4609

(57) ABSTRACT

A vibratory screening apparatus includes a frame, a deck, and a vibration generator. The frame has first and second longitudinal members and first and second transverse members. The frame is disposed about a space with the first and second longitudinal members disposed on either side of the space and the first and second transverse members disposed on either end of the space. The deck is attached to the frame with at least one screening element disposed across the space, the screening element including at least one aperture through which material moving along the deck passes through the at least one screening element. A first region extends upward from the space and a second region depends downward from the space, the first region and the second region being unobstructed. The vibration generator is coupled to the deck, and is disposed outside the first region and outside the second region.

### CROSS REFERENCE TO RELATED APPLICATIONS

This patent claims the benefit of U.S. Provisional Patent App. No. 63/763,655, filed February 26, 2025, which application is expressly incorporated herein by reference in its entirety.

### BACKGROUND

This patent is directed to a vibratory screening apparatus, and in particular to a vibratory screening apparatus with unobstructed regions above and below a screening deck of the vibratory screening apparatus.

Certain vibratory apparatuses are constructed to separate materials moving across a deck. Such vibratory apparatuses have a deck with a plurality of apertures or openings, permitting at least a first fraction of the material to move across the deck, and a second fraction of the material to pass through the deck. The first fraction includes a portion of the materials moving across the deck that cannot pass through the apertures or openings in the deck, while the second fraction includes a portion of the materials that are small enough to pass through the apertures or openings in the deck. Such a vibratory apparatus may be referred to as a separating or screening apparatus, or screen for short.

Conventionally, the screen includes a vibration generator that is mounted above the deck, or alternatively below the deck. See, for example, US Pat. No. 5,108,589, where the vibration generator is mounted above the deck. In addition, the screen will typically include a floor below the deck for collecting the materials that pass through the deck. See also, US Pat. No. 5,108,589, where the floor includes one or more chutes that collect and convey the second fraction passing through the deck.

While such a screen has advantages over other screens of the same general type, the positioning of the vibration generator above and the floor/chutes below the deck can present certain challenges. For instance, if it is necessary to repair or replace the deck, it may also be necessary to remove the structures disposed above the deck, including the vibration generator and the supporting frame. Alternatively, if it becomes necessary to clean or clear the apertures in the deck, it may be necessary to remove the chutes and associated equipment from below the deck.

It would be advantageous to overcome or substantially ameliorate one or more of the disadvantages of existing vibrating screening apparatuses with a new vibrating screening apparatus of novel and inventive design, or at least to provide a useful alternative.

### SUMMARY

According to one aspect of the present disclosure, a vibratory screening apparatus includes a frame, a deck, and a vibration generator. The frame has first and second longitudinal members and first and second transverse members. The frame is disposed about a space with the first and second longitudinal members disposed on either side of the space and the first and second transverse members disposed on either end of the space. The deck is attached to the frame with at least one screening element disposed across the space, the screening element including at least one aperture through which material moving along the deck passes through the at least one screening element. A first region extends upward from the space and a second region depends downward from the space, the first region and the second region being unobstructed. The vibration generator is coupled to the deck, and the vibration generator is disposed outside the first region and outside the second region.

According to another aspect of the present disclosure, a vibratory screening apparatus includes a frame, a deck, a plurality of resilient members, and a vibration generator. The frame has first and second longitudinal members and first and second transverse members. The frame is disposed about a space with the first and second longitudinal members disposed on either side of the space and the first and second transverse members disposed on either end of the space. The deck is attached to the frame with at least one screening element disposed across the space, the screening element including at least one aperture through which material moving along the deck passes through the at least one screening element. A first region extends upward from the space and a second region depends downward from the space, the first region and the second region being unobstructed. The plurality of resilient members is attached at a first end to the frame and at a second end to a base, the resilient members disposed outside the second region. The vibration generator is coupled to the deck, the vibration generator disposed outside the first region and outside the second region and upstream of an inlet end of the deck.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a perspective view of an embodiment of a vibratory screening apparatus;

FIG. 2 is a side view of the embodiment of the vibratory screening apparatus according to FIG. 1;

FIG. 3 is a plan view of the embodiment of the vibratory screening apparatus according to FIG. 1;

FIG. 4 is an end view of the embodiment of the vibratory screening apparatus according to FIG. 1 taken along line 4-4 in FIG. 2;

FIG. 5 is a cross-sectional view of the embodiment of the vibratory screening apparatus according to FIG. 1 taken along line 5-5 in FIG. 2;

FIG. 6 is a cross-sectional view of the embodiment of the vibratory screening apparatus according to FIG. 1 taken along line 6-6 in FIG. 2;

FIG. 7 is a side view of a first screening element and a partial side view of a second screening element that may be used with embodiments of the vibratory screening apparatus disclosed herein;

FIG. 8 is a fragmentary plan view of the first screening element of FIG. 7;

FIG. 9 is a perspective view of a first embodiment of a spring assembly or resilient member that may be used with the embodiments of a vibratory apparatus disclosed herein;

FIG. 10 is an enlarged perspective view of a distal portion of an end shank of the embodiment of a spring assembly of FIG. 9;

FIG. 11 is a perspective view of a second embodiment of a spring assembly or resilient member that may be used with the embodiments of a vibratory apparatus disclosed herein, with attachment plates;

FIG. 12 is a perspective view of the embodiment of FIG. 11, with fasteners included;

FIG. 13 is a side view of the embodiment of FIG. 11, with fasteners included;

FIG. 14 is an enlarged, perspective view of the vibration generator, or drive, of the embodiment of FIGS. 1-6, with certain elements removed for the purpose of more clearly showing other elements; and

FIG. 15 is an exploded view of the vibration generator, again with certain elements removed for the purpose of more clearly showing other elements.

### DETAILED DESCRIPTION OF VARIOUS EMBODIMENTS

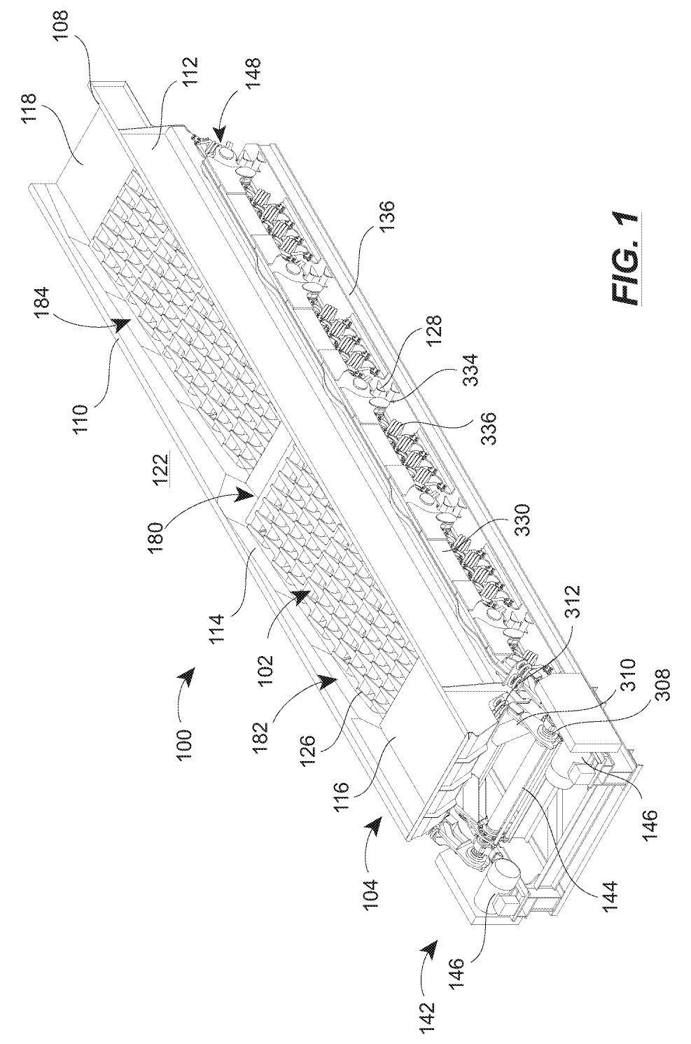

The present disclosure describes a vibratory screening apparatus that includes several features, any one of which may provide improved performance characteristics. Before discussing the features in detail, a general description of the screening apparatus, or screen, is discussed with reference to FIGS. 1-6. It is believed that this context is important to better understand how the structure and operation of the features contribute to the structure and operation of the overall screening apparatus. This description is also helpful for those unfamiliar with vibratory screening apparatuses. Having discussed the apparatus as a whole, the details of the apparatus and its variants are then discussed.

A vibratory screening apparatus 100 according to an embodiment of the present disclosure is illustrated in FIGS. 1-6. While an embodiment of the vibratory apparatus 100 is illustrated in FIGS. 1-6, the vibratory apparatus of the present disclosure is not limited to this single embodiment. A wide range of variants are possible, as will be discussed below.

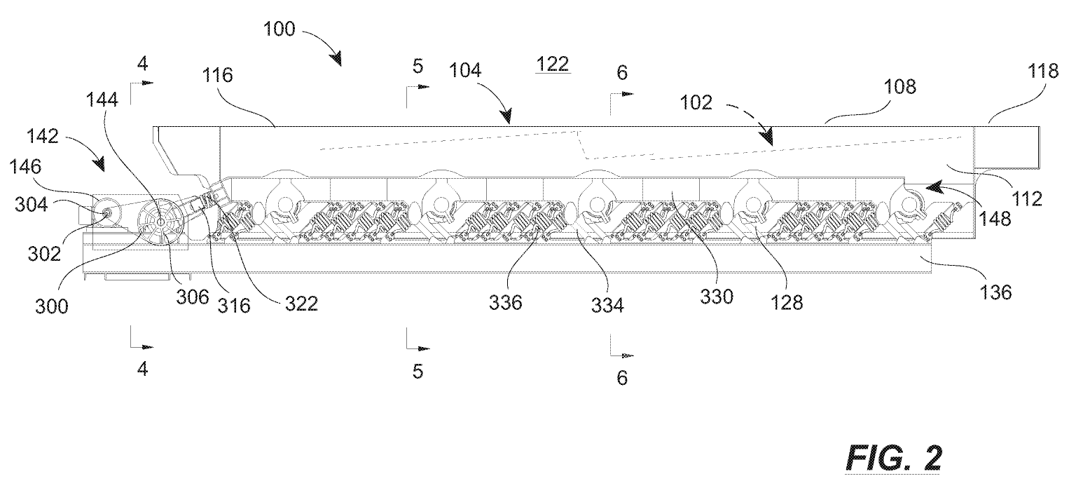

The apparatus 100 may include a deck 102. As illustrated, the deck 102 may be part of a trough 104, structures of which may define a frame 106 to which the deck 102 is attached. The frame 106 may include first and second longitudinal sides 108, 110, which may comprise first and second sidewalls 112, 114, respectively. The opposing sidewalls 112, 114 are disposed on either side of the deck 102 as illustrated in FIGS. 1 and 3-6, only the foremost of which (112) is visible in FIG. 2. The frame 106 may also include first and second transverse ends 116, 118, which may be referred to as an inlet end 116 and an outlet end 118.

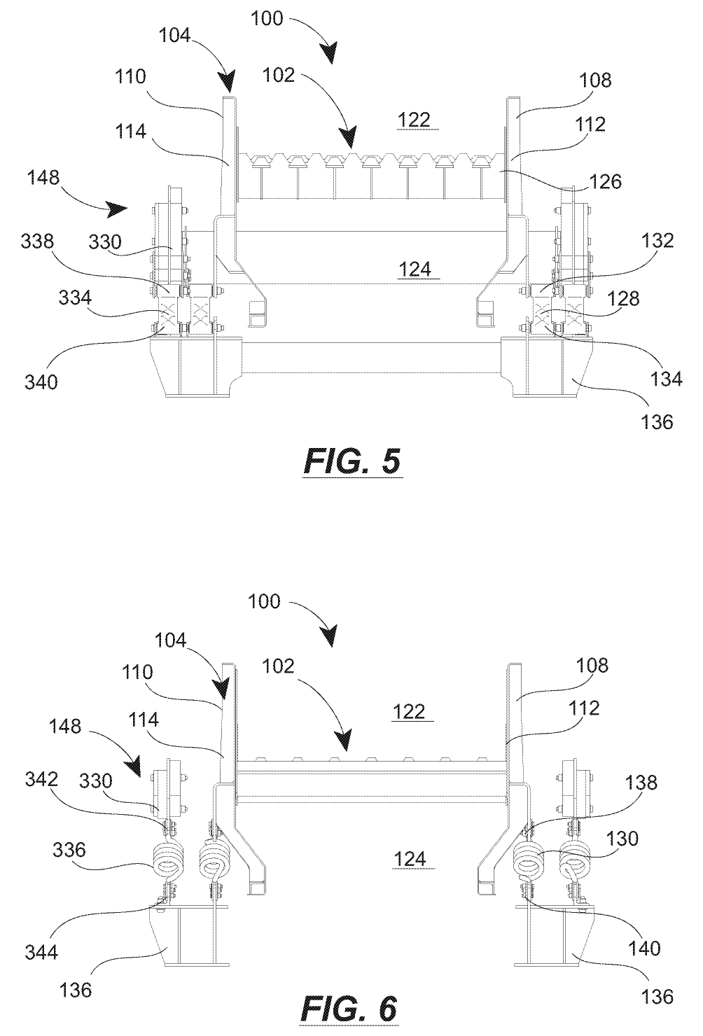

The frame 106 may define, or bound, a space across which the deck 102 is disposed. A first region 122 extends upward from the space and a second region 124 (as best seen in FIGS. 5 and 6) depends downward from the space. Unlike conventional vibratory screening apparatuses, the first and second regions 122, 124 are not obstructed by the vibration generator or other equipment. Instead, the regions 122, 124 are unobstructed.

While the degree to which the regions 122, 124 are unobstructed may vary according to different embodiments of the vibratory screening apparatus 100, it is believed that the regions 122, 124 may be considered unobstructed if the region is more than 90% free of obstructions. For example, the regions 122, 124 may be more than 92%, 94%, 95%, 96%, 98% or 100% free of obstructions. As illustrated in FIGS. 1-6, the first region 122 is 100% free of obstructions, for example. This may be referred to as completely or entirely unobstructed.

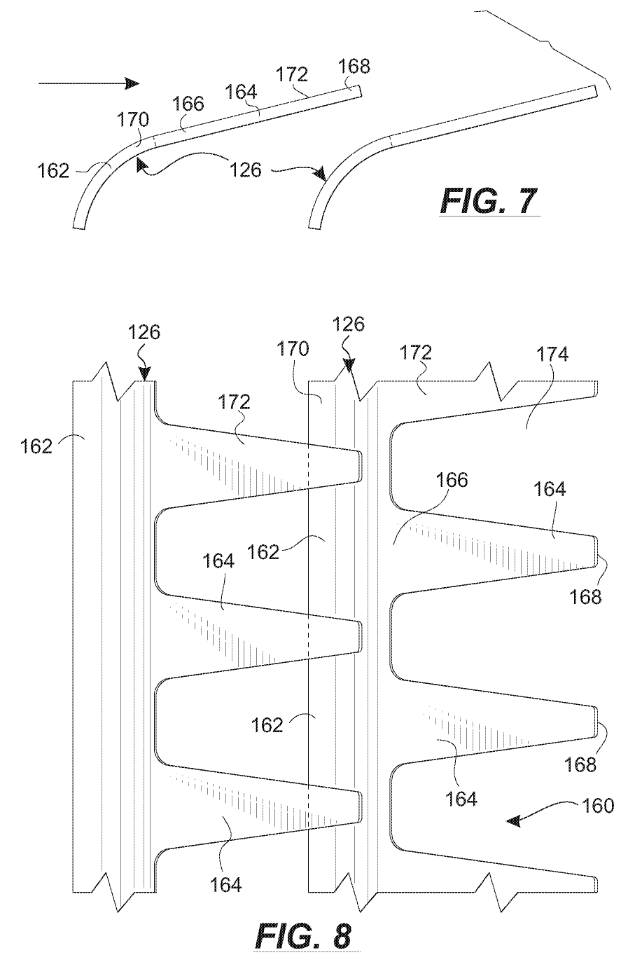

According to the illustrated embodiments, the transverse ends 116, 118 may have a solid surface, i.e., one that does not have openings, holes, or passages therethrough. On the other hand, the deck 102 may have a surface with openings, holes, or passages therethrough. As such, as materials move across or along the deck 102, the materials (or a first fraction thereof) can move across the deck 102 between the first end 116 and the second end 118, or the materials (or a second fraction thereof) can pass through the deck 102 from above the deck 102 to below the deck 102. According to the particular embodiment of the vibrating screening apparatus 100, the deck 102 is comprised of a plurality of screening elements 126 disposed across the space, as will be explained below relative to FIGS. 7 and 8. Other embodiments are possible.

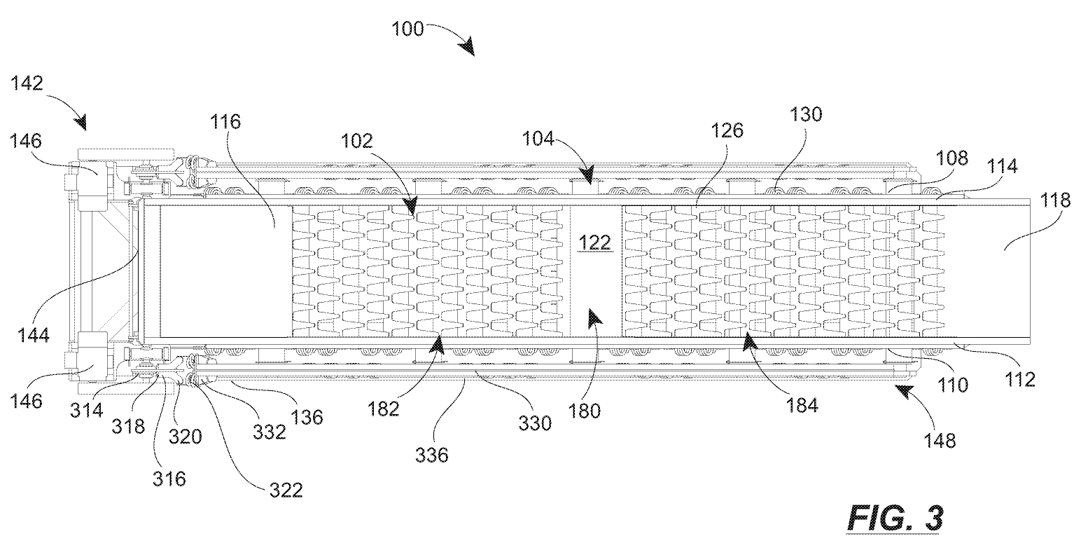

As illustrated, the deck 102 is supported above a surface. For example, the trough 104 may be supported above the surface by suspending the trough 104 from a structure disposed above the trough 104, or by supporting the trough 104 from below the trough 104. As illustrated, the trough 104 is supported by a plurality of sets or groups of links or rocker legs 128 and resilient members 130 disposed below the deck 102. Compare FIG. 3 with FIGS. 5 and 6.

The rocker legs 128 are illustrated in FIG. 5. The rocker legs 128 may be attached at a first end 132 to the trough 104 and at a second end 134 to a surface (which may be referred to as “ground” although it may be a second story of a multi-story building, for example) via a support structure or base 136 that may be supported on the surface.

The resilient members 130 are illustrated in FIG. 6. Like the rocker legs 128, the resilient members 130 may be attached at a first end 138 to the trough 104 and at a second end 140 to the base 136 that may be supported on the surface. The resilient members 130 may be disposed to make a substantially right angle with the rocker legs 128.

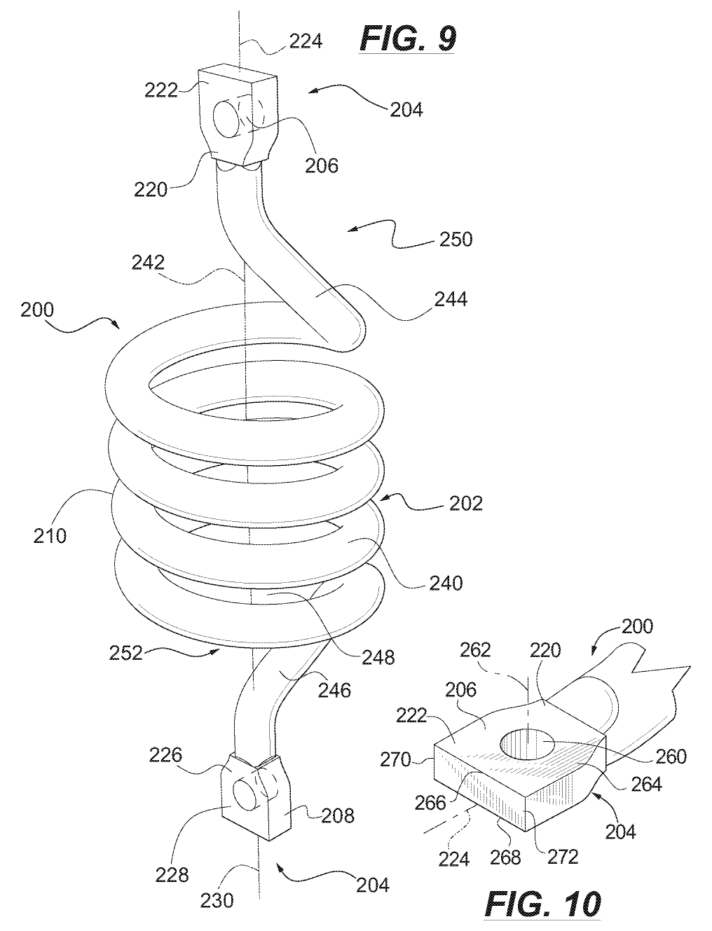

The details of the resilient members 130 are discussed below relative to FIGS. 9-13. The discussion of the resilient members 130 in the context of the structures illustrated in FIGS. 9-13 is not intended to limit the resilient members 130 only to such structures, however. Indeed, conventional coil springs may be used, such as illustrated in US Pat. Nos. 4171948 and 4844235, for example.

Still, the resilient members 130 illustrated in FIGS. 9-13 may be combined with the rocker legs 128 illustrated in FIG. 5 to provide a vibratory screening apparatus with improved stroke length. Moreover, the size and operation of the resilient members 130 permits a smaller number of resilient members 130 to be used, which permits the overall width of the apparatus 100 to be reduced because a smaller number of such resilient members 130 may be used relative to conventional coil springs, for example.

A vibration generator 142 may be coupled to the deck 102, for example via the attachment of the vibration generator 142 to the through 104. The vibration generator 142 may include a shaft 144 to which at least one (one or more) eccentric structures are arranged or attached. The vibration generator 142 may also include a motor 146 that is coupled to the shaft. Material moves in a series of throws and catches because of the controlled motion produced by the vibration generator 142.

The vibration generator 142 is positioned relative to the trough 104, and the frame 106, so as to limit obstruction of the first and second regions 122, 124. In particular, the vibration generator 142 is positioned outside the first and second regions 122, 124. In particular, the vibration generator 142 is adjacent the inlet end 116 of the apparatus 100, and is coupled to the inlet end 116 of the apparatus 100, and thus the inlet end of the trough 104. In this fashion, the vibration generator 142 is placed along a longitudinal axis of the trough 104, further reducing or limiting the width of the apparatus 100 in a transverse direction.

As will be explained below, the apparatus may include other features as well. For example, the apparatus 100 includes a counterpoise 148 to reduce or limit the transmission of forces to the surrounding supports or building. Such a counterpoise 148 may absorb or isolate a significant percentage of the reaction forces. For example, the counterpoise may absorb or isolate up to 95% of the reaction forces. In this regard, see also US Pat. No. 3,750,866, which is incorporated by reference herein in its entirety. In the embodiment of counterpoise illustrated in FIGS. 1-6, the counterpoise 148 is positively driven 180° out of phase with the trough motion (or trough, for short). This results in an equal and opposite dynamic reaction along the rigidly mounted base 136 of the apparatus 100.

As regards the operation of the vibratory screening apparatus 100, material is introduced into the trough 104 at the inlet end 116. The vibration generator 142 may then be activated (or may be activated prior to this) to cause the material to move along the deck 102. Considering the deck 102 has apertures or passages, a first fraction of the material moves across or along the deck 102, while a second fraction of the material passes through the deck 102. The first fraction exits the apparatus 100 at the outlet end 118, while the second fraction passes through the unobstructed second region 124.

The unobstructed nature of the regions 122, 124 may be achieved, in part, by virtue of the placement of the vibration generator 142 along the longitudinal axis of the apparatus 100, but outside the regions 122, 124. This placement can decrease the width of the apparatus in the transverse direction as well. The width in the transverse direction also may be reduced through the use of the resilient members 130 according to the embodiments illustrated in FIGS. 9-13, which resilient members 130 may have advantageous performance relative to conventional resilient members.

Having thus generally described the apparatus 100 to provide better context, the structure and operation of the apparatus 100, and the features thereof, are now described in detail with reference to the figures.

As discussed above, the deck 102 includes at least one screening element 126 disposed across the space. As illustrated, the embodiment of the apparatus 100 includes a plurality of screening elements 126. Moreover, these screening elements 126 include at least one aperture 160 through which material moving along the deck 102 passes through the at least one screening element 126. As illustrated, the embodiment of the screening elements 126 includes a plurality of apertures 160.

It will be recognized that the illustrated embodiment, which is illustrated in FIGS. 1-6, as well as in FIGS. 7 and 8, is but one embodiment of screening element 126 that may be used with the apparatus 100. The embodiment, as well as the deck 102 of which it is a part, provide opportunities to explain additional aspects of the present disclosure.

Turning then to FIGS. 7 and 8, the screening element 126 is of a variety that may be referred to as a finger screening element 126. The finger screening element 126 includes a backbone 162 that extends from side to side across the width (in the transverse direction) of the trough 104, and may be attached to the sidewalls 112, 114. The finger screening element also includes a plurality of cantilevered fingers 164 connected at a first end 166 to the backbone 162 and with a second, free end 168. The fingers 164 may include a first leg 170 a bend or angle in the backbone 162 to the first end 166 and a second leg 172 from the first end 166 to the second end 168.

The fingers 164 are spaced from each other by an amount selected according to the size of the particles that are intended to pass through the deck 102. The spacing of the fingers 164 creates passages 174 between the fingers 164, which passages define the apertures 160 mentioned previously.

The finger screening elements 126 may be arranged, as illustrated in FIG. 7, such that the free ends 168 of the fingers 164 overlap the finger screening elements 126 immediately forward and adjacent to the former finger screening element 126. The fingers 164 may be vertically spaced above the adjacent finger screening element 126 by a distance equal to the spacing between the fingers 164 of the screening elements 126. In this manner, particles up to the intended size should pass through the finger screening elements 126 as the material moves from the inlet end 116 to the outlet end 118.

It will be recognized that the screening elements used in other embodiments of the vibratory screening apparatus 100 according to the present disclosure may not be finger screening elements, but may be defined by other structures instead (e.g., perforated deck plates). Further, while each of the screening elements illustrated is attached to the side walls 112, 114 of the frame 106, according to other embodiments, the deck 102 may include a plurality of modular screening elements that are attached to a support structure, the support structure being attached to the side walls 112, 114.

Further, the deck 102 may include sections that are not defined by screening elements. As illustrated in the embodiment of FIGS. 1-6, the deck 102 includes a plurality of screening elements 126, but it also includes at least one section 180 where the deck does not have apertures, but the plate in this section 180 is solid. Such structures are possible along the deck 102 while not changing the unobstructed nature of the region 122 above or the region 124 below the deck 102. According to other embodiments, the entire deck 102 may be defined entirely by screening elements, however.

It will be recognized from the illustrated embodiment that it is not a requirement that the deck 102 is of a single elevation (e.g., horizontal). The deck 102 has first and second sections 182, 184 joined by the section 180, the first section 182 from the inlet end 116 to the section 180 and the second section 184 from the section 180 to the outlet end 118. Each of the first and second sections 182, 184 each have a slight increase in elevation along the length (in the longitudinal direction) of the sections 182, 184. See FIG. 2. The section 180 represents a more abrupt change in the elevation of the deck 102, or step (see particularly FIG. 2). According to other embodiments, the entire deck may be horizontal, however.

As mentioned above, the apparatus 100 includes resilient members 130 that support the apparatus 100 from below. As illustrated in FIG. 6, the resilient members 130 are disposed outside the region 124 below the space. As illustrated, the resilient members 130 may be disposed outwardly of the sidewalls 112, 114 in the transverse direction. The width of the vibratory screening apparatus 100 may be reduced or limited relative to an apparatus using a conventional spring by including the resilient members of the embodiments illustrated in FIGS. 9-13.

A spring assembly 200, which may be used for the resilient members 130, is illustrated in FIGS. 9 and 10. This does not limit the vibratory screening apparatus 100 to such a spring assembly 200, although such a spring assembly may provide potentially longer strokes than the conventional coil spring such as is illustrated in US Pat. Nos. 4171948 and 4844235, for example, and thus may provide certain advantages.

In the embodiment of FIG. 9 and 10, the spring assembly 200 includes a resilient member 202 having multiple attachment sites (at least two) 204. See FIG. 9. The resilient member 202 has a first end shank 206, a second end shank 208, and a central helical portion 210. The attachment sites 204 are disposed at each of the first end shank 206 and the second end shank 208.

The first end shank 206 extends in a first direction from the central helical portion 210 from a proximal end 220 to a distal end 222. The first end shank 206 has a longitudinal axis 224 from the proximal end 220 to the distal end 222.

The second end shank 208 extends in a second direction from the central helical portion 210 from a proximal end 226 to a distal end 228. The second end shank 208 has a longitudinal axis 230 from the proximal end 226 to the distal end 228. The second direction is opposite the first direction.

The central helical portion 210 including one or more coils 240 disposed about a central longitudinal axis 242. In addition, the central helical portion 210 has a first end 244 attached to the proximal end 220 of the first end shank 206 and a second end 246 attached to the proximal end 226 of the second end shank 208. Further, the longitudinal axis 224 of the first shank end 206, the longitudinal axis 230 of the second shank end 208, and the central longitudinal axis 242 of the central helical portion 210 are parallel to each other or are collinear (as illustrated).

The coils 240 may be spaced apart such that there are spaces 248 between coils 240 that are adjacent each other in a longitudinal direction (e.g., one above the other). Further, the coils 240 may have a curved transition 250, 252 at the first and second ends 244, 246 that attach to the first and second end shanks 206, 208, rather than an abrupt turn or bend in the coil at the first and second ends 244, 246 of the central helical portion 210. While the curved transition 250, 252 has been illustrated, other transitions are possible.

While the end shanks 206, 208 and the central helical portion 210 may comprise separate structural elements that are attached by welding, for example, the end shanks 206, 208 and the central helical portion 210 instead may be formed such that the structure of the end shanks 206, 208 and central helical portion 210 is an integral (i.e., one-piece) structure. In an integral structure, it is still proper to refer to the end shanks 206, 208 as being attached at the ends 244, 246 of the central helical portion 210, even if a joining method, such as welding, is not used to form the attachment.

The attachment site 204 is used to secure the spring assembly 200 to a vibratory apparatus. According to the illustrated embodiments, the attachment site 204 attaches the first and second end shanks 206, 208 of the spring assembly 200 to the vibratory apparatus, for example, using fasteners (e.g., nut and bolt pairs, rivets, etc.) where the axis of the fastener (e.g., the bolt) is transverse to the axes 224, 230 of the end shanks 206, 208 and the central axis 242 of the helical portion 210. An attachment site that permits the fastener to be so arranged may be referred to herein as a transverse attachment site. Such a transverse arrangement may provide one or more advantages, including a perpendicular loading of the fastener (as compared to an axial loading).

As illustrated in greater detail in FIG. 10, the end shanks (and in particular the distal end 222 of the end shank 206, as illustrated) have a hole 260 extending or depending therethrough, the hole 260 having an axis 262 that is transverse to a longitudinal axis 224 of the end shank 206. As such, if the end shank 206 were to be secured to a structure, the fastener passing through the hole 224 in the end shank 206 would be transverse to the end shank 206.

Thus, in more general terms, the embodiment of the spring assembly 200 of FIG. 10 has at least one of a first end shank and a second end shank with a hole formed therethrough. The hole has an axis that is transverse a longitudinal axis of the first end shank or the second end shank, which hole defines an attachment site. According to certain embodiments, both first end shank and the second end shank have a hole formed therethrough having an axis that is transverse to the longitudinal axis of the respective first end shank or the second end shank, which hole defines the attachment site.

FIG. 10 illustrates an embodiment where the distal end 222 of the end shank 206 is widened and flattened relative to the remainder of the end shank 206. According to this embodiment, as illustrated, the first end shank 206 includes a linear bar 264 having a quadrilateral (e.g., rectangular as illustrated, although other shapes such as a square may be possible) cross-section in a plane perpendicular to the longitudinal axis 224. The linear bar 264 has opposing sides 266, 268 of first dimension in a plane perpendicular to the axis 262 and opposing ends 270, 272 of second dimension in a plane perpendicular to the longitudinal axis 224. The first dimension is larger than the second dimension. Further, the linear bar 264 has at least one hole 260 extending between the opposing sides 266, 268 of the first end shank 206. In a similar fashion, the embodiment would also have at least one hole extending between similar opposing sides of the second end shank and defining the attachment site.

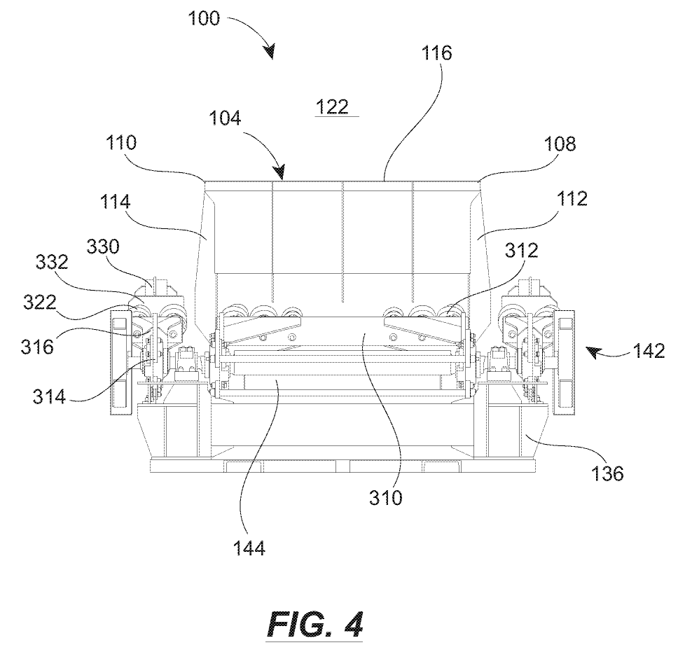

The shape of the end shank 206 in FIG. 4 is believed to provide a constant (or approximately constant) amount of material in a radial direction. This may be advantageous in addressing the stresses that may be transmitted through the end shank 206 (and in particular, the distal end 222 of the end shank 206).

According to the present disclosure, the attachment sites 204 may be used in challenging environments where water, for example, is present. In such an environment, it may be desirable to apply a layer of elastomeric material to the surfaces that contact. For example, the distal ends 222, 228 of the first and second end shanks 206, 208 may have a layer of elastomeric material applied thereto as a moisture barrier.

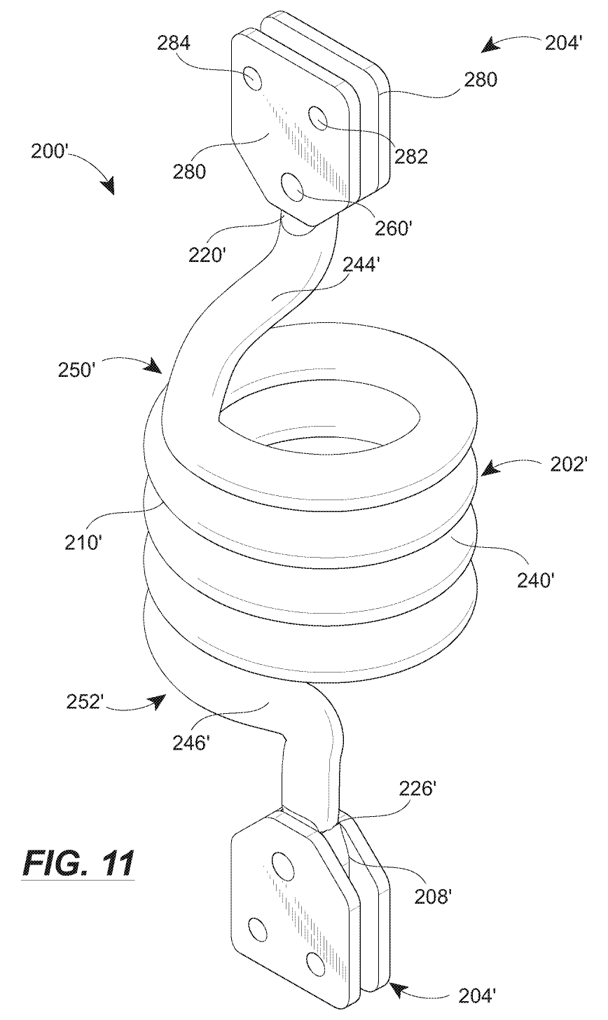

A further embodiment of the spring assembly useful in the embodiments of the vibratory screening apparatus 100 is illustrated in FIG. 11. This embodiment is in accord with the resilient member 130 illustrated in FIG. 1-6. The embodiment is the same in all respects to the embodiment of FIGS. 9 and 10, except that the transverse attachment sites of the spring assembly are paired with attachment plates, which attachment plates also include transverse attachment sites. Because of the similarity of the resilient members illustrated in FIGS. 9 and 10 and in FIGS. 11-13, the numbering of the embodiment of FIGS. 9 and 10 is used for the similar elements of the embodiment of FIGS. 11-13 (with a prime added to the numbering of FIGS. 11-13).

As illustrated in FIG. 10, the end shanks (and in particular the distal end 222 of the end shank 206, as illustrated) of the spring assembly 200 have a hole 260 extending or depending therethrough, the hole 260 having an axis 262 that is transverse to a longitudinal axis 224 of the end shank 206. Each of the end shanks 206’, 208’ of the spring assembly 200’ of the embodiment of FIG. 11 also have holes/transverse attachment sites 260’, as well as two plates 280 with a first hole that is aligned with the hole 260’ and two holes/transverse attachment sites 282, 284 that in turn are attached to the remainder of the apparatus, for example a bracket that is received between the plates 280. According to an alternative embodiment, the attachment plates 280 and attachment sites 282, 284 may instead be formed as part of the end shanks 206’, 208’ (like attachment sites 260’), either with or without the space provided between the plates 280 as illustrated in FIGS. 11-13.

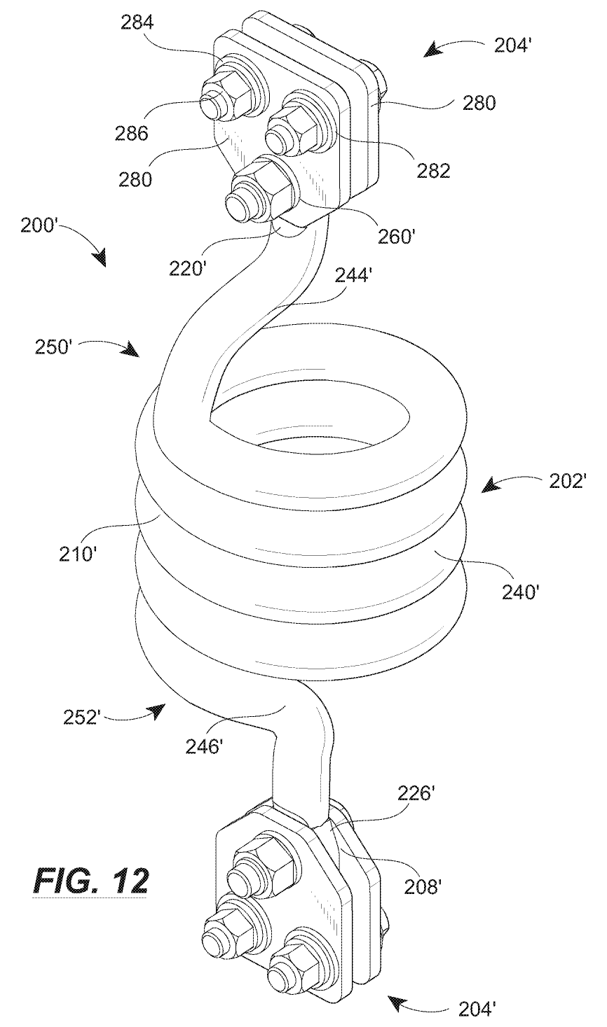

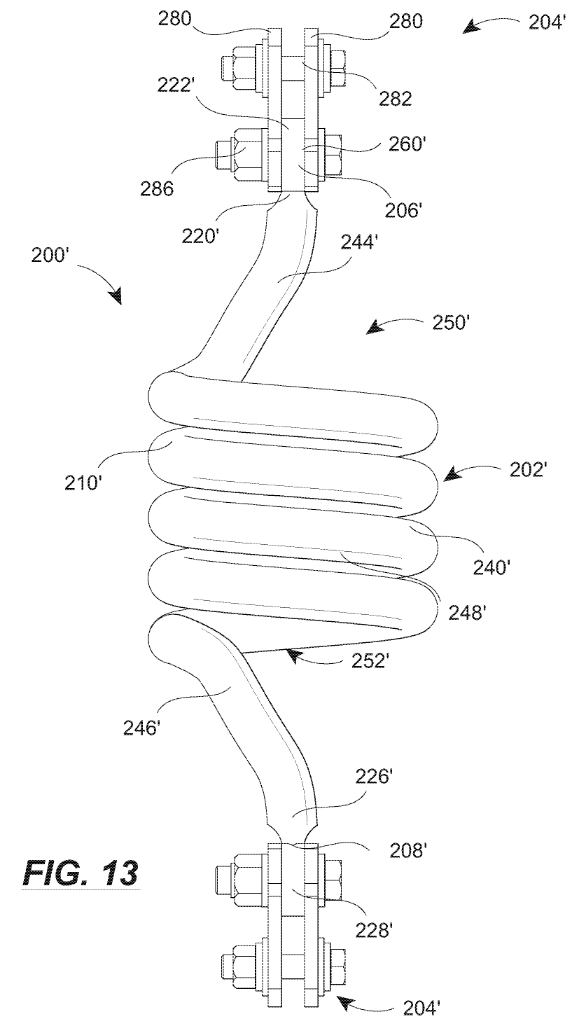

As will be recognized comparing FIG. 11 with FIGS. 12 and 13, fasteners 286 may be received in the combination of plates 280 and shanks 206’, 208’ to attach the plates 280 to the spring assembly 200’. These fasteners 286 may be in the form of bolt/nut pairs, for example, and may be received through the holes 282, 284 in the plates 280 and the hole 260’ in the shanks 206’, 208’. In a similar fashion, fasteners 286 may be received in the holes 282, 284 in the plates 280, which holes 282, 284 define transverse attachment sites. A bracket or other structural feature of the remainder of the apparatus 100 may be received between the plates 280, the bracket or other structure having holes to be aligned with the holes 282, 284. The fasteners 286 may then be disposed through the aligned holes 282, 284 and the holes in the bracket or other structure to attach the resilient members 200’ to the remainder of the apparatus 100.

Turning to FIG. 1 and FIGS. 14 and 15, the vibration generator 142 includes a shaft 144 that has one or more eccentric arranged thereon or attached thereto. The shaft 144 is coupled to a pair of electric motors 146, one of the motors 146 disposed along a first side of the apparatus 100 and the second disposed along a second side of the apparatus. As seen in FIGS. 2, 14, and 15, the motor 146 is connected via a belt 300 that is disposed about a first sheave (or wheel) 302 attached to a shaft 304 of the motor 146 and a second sheave (or wheel) 306 attached to the shaft 144. The sheaves 302, 306 may have a toothed surface to better grip the belt 300, which may also have a toothed surface.

As illustrated in FIG. 1, the shaft 144 is coupled via a pair of flange bearings 308 to a connecting assembly 310, which is in turn connected via one or more resilient members 312 in the form of coil springs to the first end 116 of the trough 104. As a consequence, vibration generated by rotation of the shaft 144 is conveyed to the trough 104 and thus to the deck 102. As illustrated in FIG. 3, the shaft is also coupled to a second pair of flange bearings 314, one disposed along the first side of the apparatus 100 and the second disposed along the second side of the apparatus 100. Each of the bearings is attached to a connecting arm 316 at a first end 318, a second end 320 of the connecting arm 318 connected via a pair of resilient members 322 to an end of the counterpoise 148 to positively drive the counterpoise 148 180 degrees out of phase relative to the trough 104.

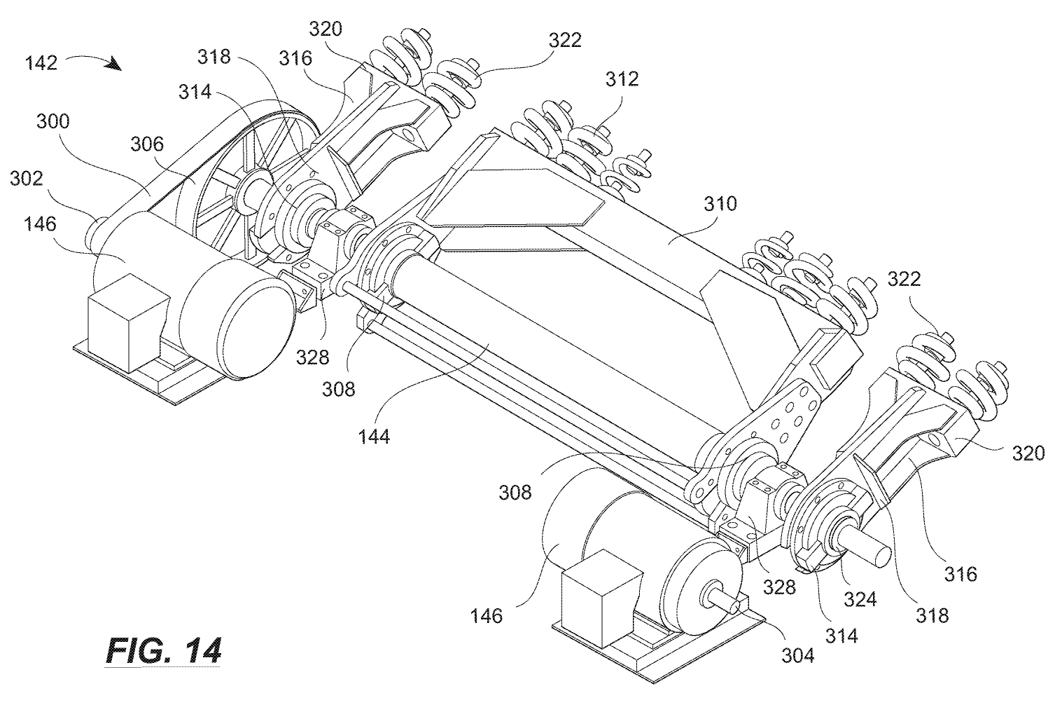

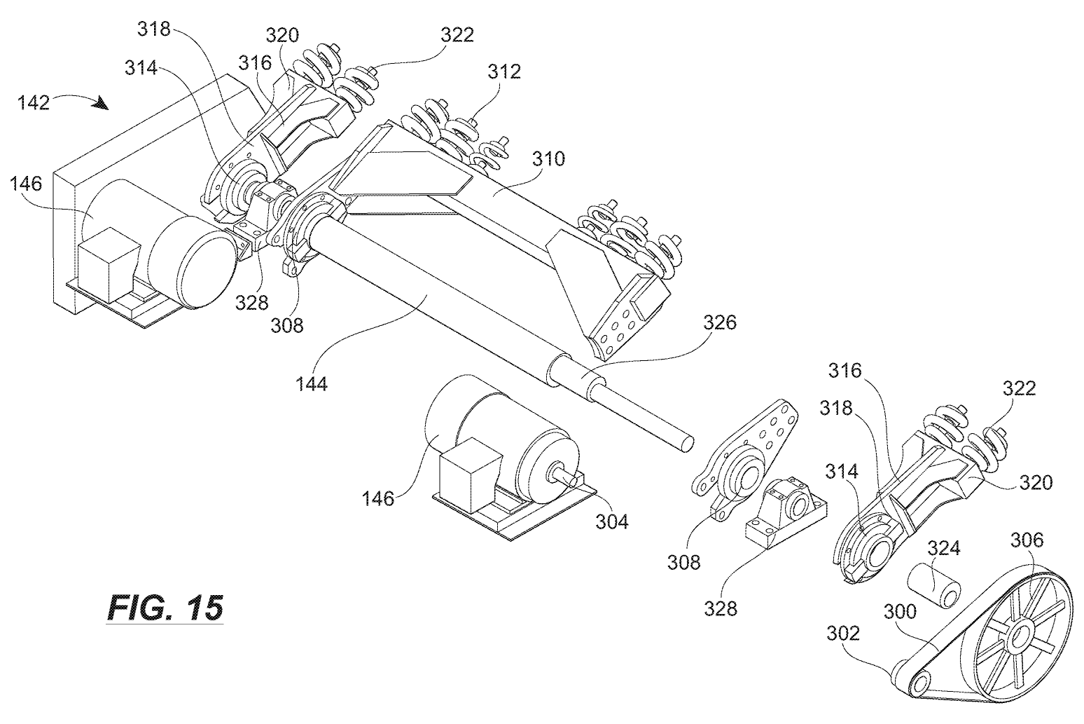

As best seen in FIG. 15, although visible in other drawings such as FIG. 14 as well, eccentric collars 324 are fitted to the shaft 144, and the flange bearings 314 are fitted to the eccentric collars 324. The eccentric collars 324 function like a crank shaft, and are used with the flange bearings 314 and arm 316 to positively drive the counterpoise 148. That is, to the extent that a section 326 of the shaft has an eccentric shape which drives the trough 104, the collar 324 has an eccentric shape which drives the counterpoise 148180 degrees out of phase relative to the trough 104. A pillow block bearing 328 may be disposed between the bearings 308 and the bearings 314/collar 324 as is illustrated in FIGS. 14 and 15.

Stated slightly differently, the eccentric axis for the section 326 may be at one instance below the pillow block center of rotation while the eccentric axis for the collar 324 may be above the center of rotation. For example, the trough flange bearing 308 may be at rest at the 5 o’clock position when viewed from the right of FIGS. 14 or 15. By comparison, the counterpoise flange bearing 314 may be at rest at the 11 o’clock position. Thus, the counterpoise 148 is driven 180 degrees out of phase with the trough 104.

As illustrated, the counterpoise 148 includes a longitudinal member 330 disposed along either side of the apparatus 100, which member may be weighted so that its operation offsets the vibration of the trough 104 that would otherwise be imparted via the base 136 to the surface on which the base 136 is disposed. For example, the weight of the counterpoise 148 may be equal to the weight of the trough 104. Either member 330 may have a bracket 332 attached thereto to connect the member 330 to the respective connecting arm 316 via the resilient members 322.

As seen in FIGS. 1 and 2, as well as FIGS. 5 and 6, the counterpoise 148 is supported on a plurality of rocker legs or links 334 and resilient members 336. As illustrated, the resilient members 336 may be of the type illustrated in FIG. 9-13, providing similar advantages for the counterpoise 148 as were provided for the trough 104 (and deck 102). As seen in FIG. 5, the legs 334 are attached at a first end 338 to the longitudinal members 330 and at a second end 338 to the base 136. As seen in FIG. 6, the resilient members 336 are attached at a first end 340 to the longitudinal members 330 and at a second end 342 to the base 136. As seen in FIG. 2, several of the resilient members 336 may be paired with at least one of the legs 334.

The illustrated counterpoise 148 is but one embodiment of a structure used to reduce or limit the transmission of forces to the surrounding supports or building. As noted above, such a counterpoise may absorb or isolate a significant percentage of the reaction forces. For example, the counterpoise may absorb or isolate up to 95% of the reaction forces.

Alternatively, a second embodiment of counterpoise may have the above structure mounted on a floating spring-mounted sub-base. Further, a third embodiment of counterpoise does not have members supported by reactor assemblies. Instead, the apparatus is mounted on a floating spring-mounted sub-base counterweighted to provide a highly efficient counterpoise action 180° out of phase with the trough 104. Still other balancers may be used, such as two separate and distinct masses, one designed to carry material and the other designed to offset dynamic loads, with the masses normally running or operated 180° out of phase. As such, the illustrated embodiments are not intended to limit the embodiments of vibratory apparatus possible.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean...” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

What is claimed is:

1. A vibratory screening apparatus comprising
a frame having first and second longitudinal members and first and second transverse members, the frame disposed about a space with the first and second longitudinal members disposed on either side of the space and the first and second transverse members disposed on either end of the space,
a deck attached to the frame with at least one screening element disposed across the space, the screening element comprising at least one aperture through which material moving along the deck passes through the at least one screening element,
a first region extending upward from the space and a second region depending downward from the space, the first region and the second region being unobstructed; and
a vibration generator coupled to the deck, the vibration generator disposed outside the first region and outside the second region.

2. The vibratory screening apparatus according to claim 1, further comprising a plurality of resilient members attached at a first end to the frame and at a second end to a base, the resilient members disposed outside the second region.

3. The vibratory screening apparatus according to claim 2, further comprising a plurality of links attached at a first end to the frame and at a second end to a base, the links disposed outside the second region.

4. The vibratory screening apparatus according to claim 1, wherein the deck has an inlet and an outlet, and the vibration generator is disposed outside the first and second spaces and coupled to the deck upstream of the inlet.

5. The vibratory screening apparatus according to claim 4, wherein the vibration generator comprises a shaft with at least one eccentric attached thereto, the shaft coupled to the deck via at least one resilient member.

6. The vibratory screening apparatus according to claim 5, further comprising a counterpoise disposed about the frame, the shaft coupled to the counterpoise via at least one resilient member to be driven 180 degrees out of phase from the deck.

7. The vibratory screening apparatus according to claim 6, wherein the shaft has an eccentric region coupled to the deck via the at least one resilient member, and an eccentric collar is fitted to the shaft and coupled to the counterpoise via the at least one resilient member, the eccentric region and the eccentric collar configured so that the counterpoise is driven 180 degrees out of phase from the deck.

8. The vibratory screening apparatus according to claim 4, wherein the vibration generator comprises at least one motor coupled to the shaft.

9. The vibratory screening apparatus according to claim 1, wherein the at least one screening element is a finger screening element having a plurality of cantilevered fingers attached to a base that is coupled at its ends to the first and second longitudinal members.

10. The vibratory screening apparatus according to claim 1, wherein the resilient member comprises:
a spring assembly having a first end shank, a second end shank, and a central helical portion,
the first end shank extending in a first direction from the central helical portion from a proximal end to a distal end, the first end shank having a longitudinal axis from the proximal end to the distal end,
the second end shank extending in a second direction from the central helical portion from a proximal end to a distal end, the second end shank having a longitudinal axis from the proximal end to the distal end, the second direction being opposite the first direction,
the first end shank and the second end shank each comprise a linear bar having a quadrilateral cross-section in a plane perpendicular to the respective longitudinal axis, and
the central helical portion including one or more coils disposed about a central longitudinal axis, the central helical portion having a first end attached to the proximal end of the first end shank and a second end attached to the proximal end of the second end shank,
the longitudinal axis of the first end shank, the longitudinal axis of the second end shank, and the central longitudinal axis of the central helical portion being collinear; and
a transverse attachment site at each of the first end shank and the second end shank configured to receive a fastener.

11. The vibratory screening apparatus according to claim 10, wherein both of the first end shank and the second end shank have at least one hole formed therethrough having an axis that is transverse to the longitudinal axis of the respective first end shank or the second end shank and defining the transverse attachment site.

12. The vibratory screening apparatus according to claim 10, wherein:
the first end shank and the second end shank comprise a linear bar having a rectangular cross-section in a plane perpendicular to the longitudinal axis,
the linear bar having opposing sides of first dimension in a plane perpendicular to the longitudinal axis and opposing ends of second dimension in a plane perpendicular to the longitudinal axis, the first dimension being larger than the second dimension,
the linear bar having at least one hole extending between the opposing sides of the first end shank and at least one hole extending between the opposing sides of the second end shank and defining the attachment site.

13. The vibratory screening apparatus according to claim 10, wherein the central helical portion comprises a plurality of coils disposed about the central longitudinal axis.

14. The vibratory screening apparatus according to claim 10, further comprising at least two attachment plates associated with each of the first end shank and the second end shank, the plates having at least one hole aligned with the transverse attachment site and at least one additional hole to form a further transverse attachment site, the plates disposed on opposite sides of the first end shank or the second end shank, respectively.

15. A vibratory screening apparatus comprising
a frame having first and second longitudinal members and first and second transverse members, the frame disposed about a space with the first and second longitudinal members disposed on either side of the space and the first and second transverse members disposed on either end of the space,
a deck attached to the frame with at least one screening element disposed across the space, the screening element comprising at least one aperture through which material moving along the deck passes through the at least one screening element,
a first region extending upward from the space and a second region depending downward from the space, the first region and the second region being unobstructed;
a plurality of resilient members attached at a first end to the frame and at a second end to a base, the resilient members disposed outside the second region; and
a vibration generator coupled to the deck, the vibration generator disposed outside the first region and outside the second region and upstream of an inlet end of the deck.

16. The vibratory screening apparatus according to claim 15, further comprising a counterpoise disposed about the frame, and wherein the vibration generator comprises a shaft with an eccentric region coupled to the deck via at least one resilient member and an eccentric collar fitted to the shaft and coupled to the counterpoise via at least one resilient member, the eccentric region and the eccentric collar configured so that the counterpoise is driven 180 degrees out of phase from the deck.

17. The vibratory screening apparatus according to claim 15, wherein the resilient member comprises:
a spring assembly having a first end shank, a second end shank, and a central helical portion,
the first end shank extending in a first direction from the central helical portion from a proximal end to a distal end, the first end shank having a longitudinal axis from the proximal end to the distal end,
the second end shank extending in a second direction from the central helical portion from a proximal end to a distal end, the second end shank having a longitudinal axis from the proximal end to the distal end, the second direction being opposite the first direction,
the first end shank and the second end shank each comprise a linear bar having a quadrilateral cross-section in a plane perpendicular to the respective longitudinal axis, and
the central helical portion including one or more coils disposed about a central longitudinal axis, the central helical portion having a first end attached to the proximal end of the first end shank and a second end attached to the proximal end of the second end shank,
the longitudinal axis of the first end shank, the longitudinal axis of the second end shank, and the central longitudinal axis of the central helical portion being collinear; and
a transverse attachment site at each of the first end shank and the second end shank configured to receive a fastener.

18. The vibratory screening apparatus according to claim 17, wherein both of the first end shank and the second end shank have at least one hole formed therethrough having an axis that is transverse to the longitudinal axis of the respective first end shank or the second end shank and defining the transverse attachment site.

19. The vibratory screening apparatus according to claim 17, wherein:
the first end shank and the second end shank comprise a linear bar having a rectangular cross-section in a plane perpendicular to the longitudinal axis,
the linear bar having opposing sides of first dimension in a plane perpendicular to the longitudinal axis and opposing ends of second dimension in a plane perpendicular to the longitudinal axis, the first dimension being larger than the second dimension,
the linear bar having at least one hole extending between the opposing sides of the first end shank and at least one hole extending between the opposing sides of the second end shank and defining the attachment site.

20. The vibratory screening apparatus according to claim 17, further comprising at least two attachment plates associated with each of the first end shank and the second end shank, the plates having at least one hole aligned with the transverse attachment site and at least one additional hole to form a further transverse attachment site, the plates disposed on opposite sides of the first end shank or the second end shank, respectively.
